(19) United States
(12) Patent Application Publication
(10) Pub. No.: US 2020/0115539 A1
(43) Pub. Date: Apr. 16, 2020

(54) HYDROGEL-FORMING COMPOSITION AND HIGHLY TRANSPARENT HYDROGEL PREPARED THEREFROM

(71) Applicant: NISSAN CHEMICAL CORPORATION, Tokyo (JP)

(72) Inventor: Yoshihiro KUDO, Funabashi-shi (JP)

(73) Assignee: NISSAN CHEMICAL CORPORATION, Tokyo (JP)

(21) Appl. No.: 16/618,675

(22) PCT Filed: May 25, 2018
(86) PCT No.: PCT/JP2018/020199

§ 371 Date: Dec. 2, 2019

(30) Foreign Application Priority Data
Jun. 2, 2017 (JP) 2017-110319
Aug. 1, 2017 (JP) 2017-149435

(51) Int. Cl. C08L 33/24; C08K 3/36; C08L 39/06; C08J 3/075

(52) U.S. Cl. CPC C08L 33/24; C08K 3/36; C08K 2201/003; C08J 3/075; C08L 39/06

(57) ABSTRACT

An organic-inorganic composite hydrogel that can be prepared only by mixing of raw materials at room temperature and has a self-supporting property. A hydrogel-forming composition capable of forming a hydrogel having a self-supporting property, the composition wherein including colloidal silica particles (A) and a polymer (B) including a unit structure of the following Formula (1):

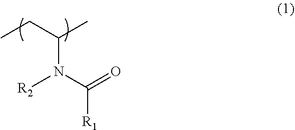

(wherein R₁ and R₂ are each independently a hydrogen atom or an optionally substituted linear, branched, or cyclic alkyl group having a carbon atom number of 1 to 10, or R₁ and R₂ are optionally bonded together to form a cyclic structure); and a hydrogel prepared therefrom.

### TECHNICAL FIELD

The present invention relates to production of a gel that can be suitably used in the fields of, for example, medical care, cosmetics, daily commodities, sanitary goods, and architecture.

### BACKGROUND ART

There has been reported a hydrogel composed of inorganic fine particles and a polymer and having a self-supporting property; specifically, an organic-inorganic composite hydrogel prepared by polymerization reaction of a (meth)acrylamide derivative in the presence of a layered clay mineral uniformly dispersed in water (Patent Document 1). A similar organic-inorganic composite hydrogel has also been reported which contains a clay mineral and a polymer composed of poly(meth)acrylamide partially including a group of a carboxylic acid salt or a carboxy anion structure (Patent Document 2).

According to these reported examples, when a monomer is polymerized in an aqueous dispersion of a layered clay mineral, the resultant polymer and the clay mineral form a three-dimensional network structure, to thereby prepare an organic-inorganic composite hydrogel.

Such an organic-inorganic composite hydrogel possibly contains unreacted monomer that may be toxic or a reagent such as a polymerization initiator. An organic-inorganic composite hydrogel is difficult to be produced by a non-chemical manufacturer. In addition, an organic-inorganic composite hydrogel is difficult to be formed into any desired shape, since the hydrogel is prepared after completion of a chemical reaction.

There has been disclosed a self-supporting organic-inorganic composite hydrogel that can be produced by mixing of raw materials at room temperature; specifically, a hydrogel containing a dendrimer compound having a polycationic functional group at its terminal and a layered clay mineral (Patent Document 3). This hydrogel poses a problem in terms of high production cost, since the dendrimer is produced by a multistage synthesis reaction.

There has also been reported an organic-inorganic composite hydrogel that can be prepared only by mixing of a polyelectrolyte, clay particles, and a dispersant with stirring (Patent Document 4). In the organic-inorganic composite hydrogel, the clay particles uniformly dispersed in the polyelectrolyte are crosslinked to form a gel structure.

In view of the foregoing, a demand has arisen for a method capable of preparing an organic-inorganic composite hydrogel having a self-supporting property only by mixing of industrially readily available raw materials at room temperature.

There has been reported an example of mixing of poly(N-vinylpyrrolidone) and silica particles; specifically, a composite gel formed of silica particles and a copolymer of N-vinylpyrrolidone with an acrylic acid ester having a trimethoxysilyl group (Non-Patent Document 1). According to this document, a crosslinking reaction by siloxylation (Si—O) between silica and the copolymer is the requirement for gelation, and no gel is formed between an N-vinylpyrrolidone homopolymer (weight average molecular weight: 44,200) causing no crosslinking reaction and silica particles having a particle diameter of 12.2 nm.

There has been reported another example of mixing of poly(N-vinylpyrrolidone) and silica particles; specifically, a mixture of poly(N-vinylpyrrolidone) having a weight average molecular weight of 55,000, fumed silica (AEROSIL 380, available from Nippon Aerosil Co., Ltd.), and water. This mixture does not undergo gelation and is in the form of suspension, since the polymer has a low molecular weight, and the silica particles have a large particle diameter (380 nm) (Non-Patent Document 2).

### PRIOR ART DOCUMENTS

### Patent Documents

Patent Document 1: Japanese Patent Application Publication No. 2002-053629 (JP 2002-053629 A)

Patent Document 2: Japanese Patent Application Publication No. 2009-270048 (JP 2009-270048 A)

Patent Document 3: International Publication WO 2011/001657 pamphlet

Patent Document 4: Japanese Patent Application Publication No. 2014-077111 (JP 2014-077111 A)

### Non-Patent Documents

Non-Patent Document 1: Chemical Communications (2011), 47 (3), 1024

Non-Patent Document 2: Polymer Science, Ser. B (2009), 51 (3-4), 135

### SUMMARY OF THE INVENTION

### Problems to be Solved by the Invention

In view of the above-described situations, an object of the present invention is to provide an organic-inorganic composite hydrogel that can be prepared only by mixing of raw materials at room temperature and has a self-supporting property. Another object of the present invention is to provide a method capable of producing the organic-inorganic composite hydrogel from industrially readily available raw materials.

### Means for Solving the Problems

The present inventor has conducted extensive studies for achieving the aforementioned objects, and as a result has found that a high-strength hydrogel having high stretchability and transparency is produced by a method involving mixing of inexpensively available polymer and inorganic fine particles in water at room temperature without the need for a polymerization reaction. The present invention has been accomplished on the basis of this finding.

Thus, in an embodiment, the present invention provides a method for producing a hydrogel comprising silica particles and a polymer containing vinylpyrrolidone.

Accordingly, the present invention provides the following.

[1] A hydrogel-forming composition capable of forming a hydrogel having a self-supporting property, the composition being characterized by comprising colloidal silica particles (A) and a polymer (B) including a unit structure of the following Formula (1):

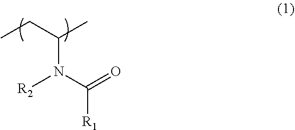

(wherein R₁ and R2 are each independently a hydrogen atom or an optionally substituted linear, branched, or cyclic alkyl group having a carbon atom number of 1 to 10, or R₁ and R₂ are optionally bonded together to form a cyclic structure).

[2] The hydrogel-forming composition according to [1], wherein the polymer (B) has a weight average molecular weight of 100,000 to 10,000,000.

[3] The hydrogel-forming composition according to [1] or [2], wherein the polymer (B) is one or more selected from the group consisting of poly(N-vinylformamide), poly(N-methyl-N-vinylformamide), poly(N-vinylacetamide), poly(N-methyl-N-vinylacetamide), poly(N-vinylpyrrolidone), poly(N-vinylcaprolactam), an N-vinylacetamide/sodium acrylate copolymer, an N-vinylpyrrolidone/vinyl acetate copolymer, and an N-vinylpyrrolidone/vinyl acetate/vinyl propionate copolymer.

[4] The hydrogel-forming composition according to any of [1] to [3], wherein the colloidal silica particles (A) are aqueous colloidal silica particles having a mean particle diameter of 1 to 500 nm.

[5] A hydrogel having a self-supporting property, the hydrogel being produced from the hydrogel-forming composition according to any of [1] to [4].

[6] A highly transparent hydrogel produced from the hydrogel-forming composition according to any of [1] to [4].

[7] A method for producing a hydrogel having a self-supporting property, the method being characterized by comprising mixing the polymer (B) according to any of [1] to [3] with colloidal silica particles (A) and water or a water-containing solvent, and causing gelation of the mixture.

[8] A method for producing a hydrogel having a self-supporting property, the method being characterized by comprising mixing the following two liquids: an aqueous solution prepared by mixing of the polymer (B) according to any of [1] to [3] with water or a water-containing solvent, and an aqueous dispersion prepared by mixing of colloidal silica particles (A) with water or a water-containing solvent, and causing gelation of the mixture.

[9] A highly transparent hydrogel having a self-supporting property, the hydrogel being produced from the hydrogel-forming composition according to any of [1] to [4].

[10] A method for producing a hydrogel having a self-supporting property, the method being characterized by comprising mixing the polymer (B) according to any of [1] to [4] with the colloidal silica particles (A) according to any of [1] to [4] and water or a water-containing solvent, and causing gelation of the mixture.

[11] A method for producing a hydrogel having a self-supporting property, the method being characterized by comprising mixing the following two liquids: an aqueous solution (liquid B) prepared by mixing of the polymer (B) according to any of [1] to [4] with water or a water-containing solvent, and an aqueous dispersion (liquid A) prepared by mixing of the colloidal silica particles (A) according to any of [1] to [4] with water or a water-containing solvent, and causing gelation of the mixture.

[12] A two-liquid combination comprising:

an aqueous solution (liquid B) prepared by mixing of a polymer (B) including a unit structure of the following Formula (1):

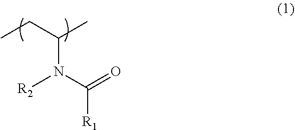

(wherein R₁ and R₂ are each independently a hydrogen atom or an optionally substituted linear, branched, or cyclic alkyl group having a carbon atom number of 1 to 10, or R₁ and R₂ are optionally bonded together to form a cyclic structure) with water or a water-containing solvent; and

an aqueous dispersion (liquid A) prepared by mixing of colloidal silica particles (A) with water or a water-containing solvent.

[13] The two-liquid combination according to [12], wherein the combination is for a hydrogel-forming composition capable of forming a hydrogel having a self-supporting property.

[14] The two-liquid combination according to [12] or [13], wherein the combination is for a composition for forming a hydrogel further having high transparency.

### Effects of the Invention

The production method of the present invention can produce a hydrogel having a self-supporting property (preferably, high transparency) in a simple and safe manner.

### BRIEF DESCRIPTION OF THE DRAWINGS

FIG. 1 is a graph showing the stress-strain curves of hydrogels produced in Examples 1 and 2.

FIG. 2 is a graph showing the results of measurement of the transmittance of a hydrogel produced in Example 2.

### MODES FOR CARRYING OUT THE INVENTION

### Hydrogel-Forming Composition

The hydrogel-forming composition of the present invention can form a hydrogel having a self-supporting property. The hydrogel-forming composition is characterized by comprising colloidal silica particles (A) and a polymer (B) including a unit structure of the following Formula (1):

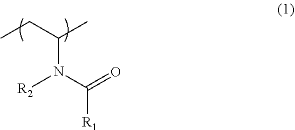

(wherein R₁ and R₂ are each independently a hydrogen atom or an optionally substituted linear, branched, or cyclic alkyl group having a carbon atom number of 1 to 10, or R₁ and R₂ are optionally bonded together to form a cyclic structure).

The term “optionally substituted” as used herein refers to the case where some or all of the hydrogen atoms of the aforementioned alkyl group may be substituted with, for example, a hydroxy group, a halogen atom, a carboxyl group, a nitro group, a cyano group, a methylenedioxy group, an acetoxy group, a methylthio group, an amino group, or a C₁₋₉ alkoxy group.

Even when R₁ and R₂ are bonded together to form a cyclic structure, some or all of the substitutable hydrogen atoms present in the cyclic structure may be substituted with, for example, a hydroxy group, a halogen atom, a carboxyl group, a nitro group, a cyano group, a methylenedioxy group, an acetoxy group, a methylthio group, an amino group, or a C₁₋₉ alkoxy group.

Examples of the linear, branched, or cyclic alkyl group having a carbon atom number of 1 to 10 include linear alkyl groups, such as methyl group, ethyl group, n-propyl group, n-butyl group, n-pentyl group, n-hexyl group, n-heptyl group, n-octyl group, n-nonyl group, and n-decyl group; branched alkyl groups, such as isopropyl group, sec-butyl group, tert-butyl group, isopentyl group, neopentyl group, 1-methylpentyl group, isohexyl group, 1-propylbutyl group, 2-ethylhexyl group, and isononyl group; and cyclic alkyl groups, such as cyclopropyl group, cyclobutyl group, cyclopentyl group, cyclohexyl group, p-tert-butylcyclohexyl group, and adamantyl group. Preferred are methyl group, ethyl group, n-propyl group, n-butyl group, isopropyl group, sec-butyl group, and tert-butyl group, and more preferred are methyl group, ethyl group, isopropyl group, sec-butyl group, and tert-butyl group.

Examples of the aforementioned halogen atom include fluorine atom, chlorine atom, bromine atom, and iodine atom.

Examples of the aforementioned C₁₋₉ alkoxy group include methoxy group, ethoxy group, n-propoxy group, i-propoxy group, n-butoxy group, i-butoxy group, s-butoxy group, t-butoxy group, n-pentoxy group, 1-methyl-n-butoxy group, 2-methyl-n-butoxy group, 3-methyl-n-butoxy group, 1,1-dimethyl-n-propoxy group, 1,2-dimethyl-n-propoxy group, 2,2-dimethyl-n-propoxy group, 1-ethyl-n-propoxy group, n-hexyloxy group, 1-methyl-n-pentyloxy group, 2-methyl-n-pentyloxy group, 3-methyl-n-pentyloxy group, 4-methyl-n-pentyloxy group, 1,1-dimethyl-n-butoxy group, 1,2-dimethyl-n-butoxy group, 1,3-dimethyl-n-butoxy group, 2,2-dimethyl-n-butoxy group, 2,3-dimethyl-n-butoxy group, 3,3-dimethyl-n-butoxy group, 1-ethyl-n-butoxy group, 2-ethyl-n-butoxy group, 1,1,2-trimethyl-n-propoxy group, 1,2,2-trimethyl-n-propoxy group, 1-ethyl-l-methyl-n-propoxy group, 1-ethyl-2-methyl-n-propoxy group, n-heptyloxy group, n-octyloxy group, and n-nonyloxy group.

Examples of the cyclic structure formed through bonding of R₁ and R₂ include β-propiolactam, γ-butyrolactam, δ-valerolactam, and ε-caprolactam. Preferred are γ-butyrolactam and ε-caprolactam, and most preferred is γ-butyrolactam.

The term “self-supporting property” of a hydrogel, which is usually used without being defined in academic papers and patent documents, is used herein to mean that the hydrogel has a sufficient strength, and thus the shape of the hydrogel can be maintained even in the absence of a support (e.g., a container).

The elastic modulus of the hydrogel of the present invention, which is used as an index of the self-supporting property of the hydrogel of the present invention, can be measured with, for example, a piercing strength measuring apparatus. For example, a cylindrical hydrogel having a diameter of 28 mm and a height of 16 mm is prepared, and the elastic modulus of the hydrogel can be measured with Autograph AGS-X 500N available from SHIMADZU CORPORATION. For determination of the elastic modulus, the hydrogel is compressed at a rate of 1 mm/sec, and stresses are measured at strain rates of 50% and 80%. A stress-strain curve is prepared from the results of the measurement, and the elastic modulus can be determined from the gradient of a region of the stress-strain curve where the strain rate is low. In the present invention, the elastic modulus of the hydrogel, which is determined with a piercing strength measuring apparatus, may vary depending on the amounts of components used and the compositional proportions of the components. The elastic modulus is, for example, 0.1 to 5,000 kPa, for example, 50 to 5,000 kPa, for example, 100 to 5,000 kPa, preferably 0.5 to 2,500 kPa, most preferably 0.5 to 500 kPa.

### Polymer (B)

The polymer (B) including a unit structure of Formula (1) is prepared through polymerization of a monomer of the following Formula (1-1):

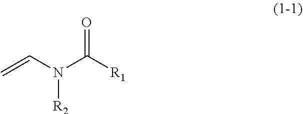

(wherein R₁ and R₂ are as defined above) by any known method.

Specific examples of the monomer include N-vinylformamide, N-methyl-N-vinylformamide, N-vinylacetamide, N-methyl-N-vinylacetamide, N-vinylcaprolactam, and N-vinylpyrrolidone. Of these, N-vinylpyrrolidone is preferred.

The polymer (B) may be a homopolymer of a compound of Formula (1-1). Examples of the homopolymer include poly(N-vinylformamide), poly(N-methyl-N-vinylformamide), poly(N-vinylacetamide), poly(N-methyl-N-vinylacetamide), poly(N-vinylpyrrolidone), and poly(N-vinylcaprolactam). Poly(N-vinylpyrrolidone) is preferred.

The polymer (B) may be a copolymer of a compound of Formula (1-1) with another monomer. Examples of the copolymer include an N-vinylacetamide/sodium acrylate copolymer, an N-vinylpyrrolidone/vinyl acetate copolymer, and an N-vinylpyrrolidone/vinyl acetate/vinyl propionate copolymer.

The polymer (B) is composed of one or more polymers, preferably three or less polymers, more preferably two polymers, most preferably one polymer.

The amount by mole of the unit structure of Formula (1) relative to the entire polymer (B) is, for example, 20% by mole or more, for example, 30% by mole or more, for example, 50% by mole or more, for example, 70% by mole or more, for example, 80% by mole or more, for example, 90% by mole or more, most preferably 100% by mole.

No particular limitation is imposed on the amount of the polymer (B) relative to the entire hydrogel-forming composition, so long as the hydrogel of the present invention can be formed from the composition. The amount of the polymer (B) is, for example, 0.01 parts to 30 parts, preferably 0.1 parts to 20 parts.

No particular limitation is imposed on the weight average molecular weight of the polymer (B), so long as the hydrogel can be formed from the composition. The weight average molecular weight is preferably 100,000 to 10,000,000, more preferably 200,000 to 5,000,000, still more preferably 500,000 to 5,000,000.

### Colloidal Silica Particles (A)

No particular limitation is imposed on the colloidal silica particles (A) used in the present invention, so long as they are in the form of a colloid of SiO₂ or a hydrate thereof. The colloidal silica particles (A) have a mean particle diameter of, for example, 1 to 500 nm, for example, 2 to 400 nm, for example, 3 to 300 nm, for example, 4 to 200 nm, for example, 4 to 100 nm.

The mean particle diameter of the colloidal silica particles (A) is determined by any known method (e.g., the BET method, centrifugation, the Sears method, or dynamic light scattering).

The colloidal silica particles (A) are usually prepared by reaction of a silicate salt with dilute hydrochloric acid and dialysis of the reaction product, and are in the form of a sol that does not precipitate usually at ambient temperature. The colloidal silica particles (A) may be commercially available. Examples of the commercially available product include SNOWTEX (registered trademark) (available from Nissan Chemical Corporation), Adelite (registered trademark) (available from ADEKA CORPORATION), Silicadol (registered trademark) (available from NIPPON CHEMICAL INDUSTRIAL CO., LTD.), and Quartron (available from FUSO CHEMICAL CO., LTD.). Aqueous dispersion-type colloidal silica is particularly preferred. Examples of the colloidal silica include SNOWTEX (registered trademark) XS, S, 30, 50, 30 L, and XL (in the form of Na³⁰-stabilized alkaline sol having a particle diameter of 4 to 60 nm); SNOWTEX (registered trademark) CXS, C, and CM (colloidal silica having improved stability with respect to, for example, a change in pH); SNOWTEX (registered trademark) OXS, OS, O, O-40, and OL (acidic colloidal silica (e.g., pH: 2 to 4)); SNOWTEX (registered trademark) NXS, NS, N, and N-40 (alkaline colloidal silica (e.g., pH: 9 to 10)); and SNOWTEX (registered trademark) AK-XS, AK, AK-L, and AK-YL (in the form of surface cationic acidic sol having a mean particle diameter of 4 to 80 nm). Of these, preferred are SNOWTEX (registered trademark) XS, S, 30, 50, 30 L, and XL (in the form of Na⁺-stabilized alkaline sol having a particle diameter of 4 to 60 nm) or SNOWTEX (registered trademark) AK-XS, AK, AK-L, and AK-YL (in the form of surface cationic acidic sol having a mean particle diameter of 4 to 80 nm), and most preferred are SNOWTEX (registered trademark) XS, S, 30, 50, 30 L, and XL (in the form of Natstabilized alkaline sol having a particle diameter of 4 to 60 nm).

No particular limitation is imposed on the amount of the colloidal silica particles used, so long as the hydrogel can be formed from the hydrogel-forming composition. The amount of the colloidal silica particles is, for example, 0.01 parts to 30 parts, preferably 1 part to 20 parts, relative to 100 of the entire hydrogel-forming composition.

### Hydrogel Having Self-Supporting Property

The hydrogel having a self-supporting property is formed from the aforementioned hydrogel-forming composition. The terms “hydrogel-forming composition” and “self-supporting property” are as described above.

### Highly Transparent Hydrogel

The hydrogel of the present application preferably has high transparency. The term “high transparency” specifically refers to a transmittance (%) of 80% or more (more preferably 90% or more) at 400 nm to 800 nm as measured by the method described in the examples or a method similar thereto.

### Production Method for Hydrogel

The hydrogel having a self-supporting property of the present invention can be produced by mixing the polymer (B) with the colloidal silica particles (A) and water or a water-containing solvent, and allowing the resultant mixture to stand still.

For example, the hydrogel of the present invention can be produced by mixing the following two liquids: an aqueous solution (liquid B) prepared by mixing of the polymer (B) with water or a water-containing solvent, and an aqueous dispersion (liquid A) prepared by mixing of the colloidal silica particles (A) with water or a water-containing solvent, and causing gelation of the resultant mixture.

One additional solution (liquid C) may be mixed so long as the aforementioned self-supporting property is not lost.

In such a case, three liquids are used in total (including the aforementioned two liquids).

Furthermore, one or more additional solutions may be mixed so long as the self-supporting property is not lost.

In such a case, four or more liquids are used in total (including the aforementioned three liquids).

Each of the hydrogel-forming composition and hydrogel of the present invention may contain, as a water-containing solvent, a water-containing alcohol and a water-containing polyhydric alcohol. As used herein, the term “water-containing alcohol” refers to a mixed solution of a monohydric alcohol and water, whereas the term “water-containing polyhydric alcohol” refers to a mixed solution of a polyhydric alcohol and water.

The aforementioned monohydric alcohol is preferably a water-soluble alcohol that dissolves freely in water, more preferably a C₁₋₈ alcohol. Examples of the monohydric alcohol include methanol, ethanol, 2-propanol, i-butanol, pentanol, hexanol, 1-octanol, and isooctanol.

The aforementioned polyhydric alcohol is a di- or more-valent alcohol. Examples of the polyhydric alcohol include glycerin, polyglycerin (e.g., diglycerin, triglycerin, or tetraglycerin), ethylene glycol, propylene glycol, polyethylene glycol (e.g., PEG 600), diethylene glycol, triethylene glycol, tetraethylene glycol, dipropylene glycol, 1,5-pentanediol (pentamethylene glycol), 1,2,6-hexanetriol, octylene glycol (ethohexadiol), butylene glycol (e.g., 1,3-butylene glycol, 1,4-butylene glycol, or 2,3-butanediol), hexylene glycol, 1,3-propanediol (trimethylene glycol), and 1,6-hexanediol (hexamethylene glycol). Of these, preferred are glycerin, diglycerin, ethylene glycol, propylene glycol, and polyethylene glycol.

The amount of the water-containing alcohol or the water-containing polyhydric alcohol is 0% by mass to 80% by mass, preferably 0% by mass to 60% by mass, in 100% by mass of the hydrogel.

The amount of the alcohol contained in the water-containing alcohol or the water-containing polyhydric alcohol is 0.1% by mass to 80% by mass, preferably 0.1% by mass to 60% by mass, in 100% by mass of the water-containing alcohol or the water-containing polyhydric alcohol.

The components of the hydrogel-forming composition can be mixed by mechanical or manual stirring, or ultrasonic treatment, and preferably mixed by mechanical stirring. The mechanical stirring can be performed with, for example, a magnetic stirrer, a propeller-type stirrer, a planetary centrifugal mixer, a disper, a homogenizer, a shaker, a vortex mixer, a ball mill, a kneader, a line mixer, or an ultrasonic oscillator. Of these, a magnetic stirrer, a propeller-type stirrer, a planetary centrifugal mixer, and a line mixer are preferably used for mixing.

The temperature during mixing is the freezing point to the boiling point of the aqueous solution or the aqueous dispersion, preferably −5° C. to 100° C., more preferably 10° C. to 80° C.

Although the mixture has low strength and is in the form of sol immediately after completion of the mixing, the mixture gelates after being allowed to stand still. The mixture is preferably allowed to stand still for 2 hours to 100 hours. The mixture is allowed to stand still at a temperature of −5° C. to 100° C., preferably 0° C. to 50° C. When the mixture is poured into a mold or subjected to extrusion molding immediately after completion of the mixing and before gelation, the mixture can be formed into a gel having any desired shape.

The stirring may be performed with a stirring blade or a stirring bar, or may be performed with a homogenizer or a planetary centrifugal mixer (e.g., ARE-310 available from THINKY CORPORATION, or V-mini 300 available from EME Corporation).

In the case where the aforementioned silica particles are mixed with the polymer (B), for example, a previously prepared aqueous solution of the polymer (B) may be mixed with an aqueous dispersion of the silica particles. Alternatively, the silica particles and the polymer (B) may be mixed in a powder state, and water may be added to the resultant powder mixture with stirring, to thereby prepare a gel.

The silica particles and the polymer (B) are mixed at a temperature of, for example, 0° C. to 100° C., preferably 5° C. to 80° C.

So long as the aforementioned self-supporting property is not lost, an additional additive may be added during preparation of the hydrogel. Examples of the additive include a salt such as sodium chloride, an alcohol such as glycerin or ethanol, a water-soluble substance such as urea, a surfactant, or a dye, a deoxidizer, a polymerization inhibitor, a stabilizer such as a preservative, an antibacterial agent, a bactericide, an ultraviolet absorber, an acid, an alkali, a pH buffer, a pigment, a perfume, a cosmetic additive, and any water-insoluble substance. Thus, a gel can be prepared to fit its intended use (e.g., imparting of functionality).

The aforementioned additive may be added to the liquid B and/or the liquid A, or may be added to a mixture of the liquid B and the liquid A.

The hydrogel has fluidity immediately after preparation thereof, and thus it can be stretched into a sheet or a string, or can be poured into, for example, a mold to form any desired shape.

Since the hydrogel of the present invention has high water content, high transparency, and high stretchability, it can be suitably used, as a soft material, in a variety of fields of, for example, medical care, cosmetics, daily commodities, sanitary goods, and architecture.

The hydrogel of the present invention can also be dried, and thus it can exhibit high water absorbability, water retentivity, and swellability.

Since each of the components of the hydrogel of the present invention is recognized to have high safety, the hydrogel can be safely used in applications for, for example, medical care, cosmetics, foods, toys, and sanitary goods.

Examples of the applications of the hydrogel include external medicine bases, such as wound dressings, cataplasms, and hemostatic materials; sealant materials for surgery; scaffold materials for regenerative medicine; implant materials, such as artificial corneas, artificial lenses, artificial vitreous bodies, artificial skin, artificial joints, artificial cartilage, and materials for breast augmentation; medical materials, such as materials for soft contact lenses; medium materials for tissue culturing, microbial culturing, etc.; cosmetic materials, such as sheets for packing; sanitary materials, such as diapers for children and adults and sanitary napkins; gel materials for aromatics or deodorants; confectionery or gum materials for dogs; materials for chromatographic carriers; materials for bioreactor carriers; materials for separation membranes; building and civil engineering materials, such as noncombustible materials for building materials, fireproofing covering materials, humidity control materials, refrigerants, aseismic buffer materials, mudflow preventing materials, and sandbags; greening materials, such as soil water retention agents, raising seedling media, or agricultural and horticultural hydroponic supports; toy materials, such as children's toys or models; materials for stationery; shock absorbing materials for sporting goods, such as sports shoes and protectors; cushion materials for shoe soles; buffer materials for bulletproof vests; buffer materials for automobiles, etc.; buffer materials for transportation; packing materials; buffering/protecting mat materials; shock absorbers within electronic devices; buffer materials for transporting wagons for precision components, such as optical devices and semiconductor-related components; vibration-proof/damping materials for industrial equipment; sound reduction materials for industrial equipment, such as equipment using motor and compressors; environment-conscious materials, such as rubber substitute materials for tires and rubber bands, and plastic substitute materials; coating materials for frictional parts of devices; coating additives; waste disposal agents, such as gelators for waste mud and lost circulation preventing agents; adhesives; sealants for sealing; gel electrolyte materials for primary cells, secondary cells, and capacitors; electronic materials, such as gel electrolyte materials for dye-sensitized solar cells or materials for fuel cells; and materials for photographic films.

### EXAMPLES

The present invention will next be described in detail by way of examples, which should not be construed as limiting the invention thereto.

### (Example 1) Production of Hydrogel Containing 5% Polymer (B)

5 Parts of polyvinylpyrrolidone (PITZCOL K-90, available from DKS Co. Ltd.) (weight average molecular weight: 1,200,000) was mixed with 70 parts of water, and the mixture was stirred at room temperature for one hour. 25 Parts of SNOWTEX (registered trademark) XS (available from Nissan Chemical Corporation, silica concentration: 20%, mean particle diameter as measured by the Sears method: 4 to 6 nm) was added to the mixture, and the resultant mixture was vigorously stirred for three minutes. Thereafter, the mixture was allowed to stand still for 24 hours, to thereby produce a hydrogel.

### (Example 2) Production of Hydrogel Containing 10% Polymer (B)

10 Parts of polyvinylpyrrolidone (PITZCOL K-90, available from DKS Co. Ltd.) (weight average molecular weight: 1,200,000) was mixed with 40 parts of water, and the mixture was stirred at room temperature for one hour. 50 Parts of SNOWTEX (registered trademark) XS (available from Nissan Chemical Corporation, silica concentration: 20%, mean particle diameter as measured by the Sears method: 4 to 6 nm) was added to the mixture, and the resultant mixture was stirred with a planetary centrifugal mixer (V-mini 300, available from EME Corporation) for three minutes. Thereafter, the mixture was allowed to stand still for 24 hours, to thereby produce a hydrogel.

### (Example 3) Hydrogel Compression Test

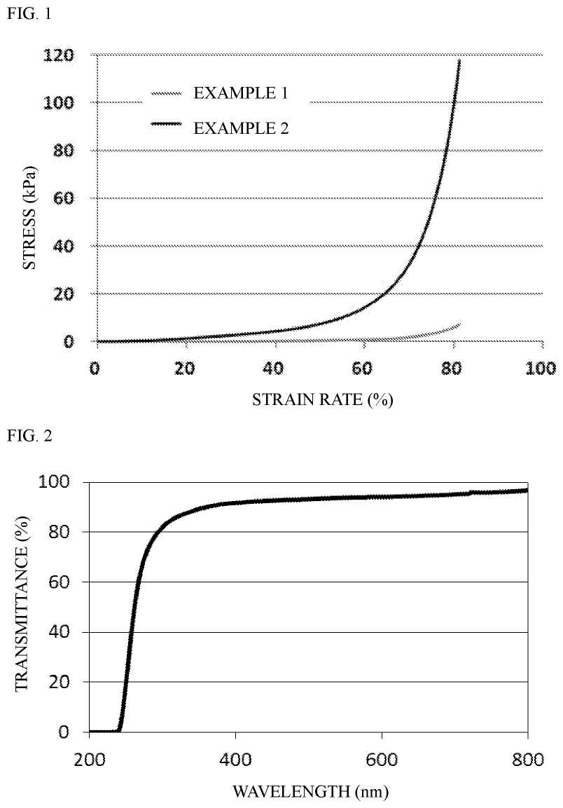

A cylindrical hydrogel having a diameter of 28 mm and a height of 16 mm was prepared under each of the conditions of Examples 1 and 2. The compressive strength of the hydrogel was measured with Autograph AGS-X SOON available from SHIMADZU CORPORATION. For measurement of the compressive strength, the hydrogel was compressed at a rate of 1 mm/sec, and stresses were measured at strain rates of 50% and 80%. The elastic modulus was determined from the gradient of a region of the stress-strain curve where the strain rate was low. The results of the measurement are shown in Table 1 and FIG. 1.

TABLE 1

| | Stress at 50% | Stress at 80% | |
|---|---|---|---|
| | strain rate | strain rate | Elastic modulus |
| | [kPa] | [kPa] | [kPa] |
| Example 1 | 0.4 | 5.9 | 1.0 |
| Example 2 | 7.4 | 99.4 | 16.2 |

### (Example 4) Measurement of Transmittance of Hydrogel

The hydrogel produced in Example 2 was formed into a hydrogel sheet having a thickness of 3 mm. The transmittance of the hydrogel sheet was measured with UV-3600 available from SHIMADZU CORPORATION at a wavelength of 200 to 800 nm. The results of the measurement are shown in FIG. 2.

### INDUSTRIAL APPLICABILITY

The present invention relates to a gel that can be suitably used in the fields of, for example, medical care, cosmetics, daily commodities, sanitary goods, and architecture.

1. A hydrogel-forming composition capable of forming a hydrogel having a self-supporting property, the composition comprising colloidal silica particles (A) and a polymer (B) including a unit structure of the following Formula (1): 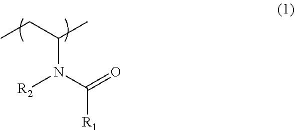
(wherein R₁ and R₂ are each independently a hydrogen atom or an optionally substituted linear, branched, or cyclic alkyl group having a carbon atom number of 1 to 10, or R₁ and R₂ are optionally bonded together to form a cyclic structure).

2. The hydrogel-forming composition according to claim 1, wherein the polymer (B) has a weight average molecular weight of 100,000 to 10,000,000.

3. The hydrogel-forming composition according to claim 1, wherein the polymer (B) is one or more selected from the group consisting of poly(N-vinylformamide), poly(N-methyl-N-vinylformamide), poly(N-vinylacetamide), poly(N-methyl-N-vinylacetamide), poly(N-vinylpyrrolidone), poly(N-vinylcaprolactam), an N-vinylacetamide/sodium acrylate copolymer, an N-vinylpyrrolidone/vinyl acetate copolymer, and an N-vinylpyrrolidone/vinyl acetate/vinyl propionate copolymer.

4. The hydrogel-forming composition according to claim 1, wherein the colloidal silica particles (A) are aqueous colloidal silica particles having a mean particle diameter of 1 to 500 nm.

5. A hydrogel having a self-supporting property, the hydrogel being produced from the hydrogel-forming composition according to claim 1.

6. A highly transparent hydrogel produced from the hydrogel-forming composition according to claim 1.

7. A method for producing a hydrogel having a self-supporting property, the method wherein comprising mixing the polymer (B) according to claim 1 with colloidal silica particles (A) and water or a water-containing solvent, and causing gelation of the mixture.

8. A method for producing a hydrogel having a self-supporting property, the method comprising mixing the following two liquids: an aqueous solution (liquid B) prepared by mixing of the polymer (B) according to claim 1 with water or a water-containing solvent, and an aqueous dispersion (liquid A) prepared by mixing of colloidal silica particles (A) with water or a water-containing solvent, and causing gelation of the mixture.
